(19) United States
(12) Patent Application Publication
(10) Pub. No.: US 2023/0362668 A1
(43) Pub. Date: Nov. 9, 2023

(54) METHOD AND DEVICE IN NODES USED FOR WIRELESS COMMUNICATION

(71) Applicant: Lu WU, Shanghai (CN)

(72) Inventor: Lu WU, Shanghai (CN)

(73) Assignee: SHANGHAI TUILUO COMMUNICATION TECHNOLOGY PARTNERSHIP (LIMITED PARTNERSHIP), Shanghai (CN)

(21) Appl. No.: 18/223,042

(22) Filed: Jul. 18, 2023

Related U.S. Application Data
(63) Continuation of application No. PCT/CN2022/072872, filed on Jan. 20, 2022.

(30) Foreign Application Priority Data
Jan. 26, 2021 (CN) 202110101278.8

(51) Int. Cl. H04W 72/0453; H04L 5/00; H04W 16/28

(52) U.S. Cl. CPC H04W 16/28; H04L 5/0048; H04W 72/0453

(57) ABSTRACT

The present application discloses a method and a device in a node for wireless communications. A first node receives a second signaling and operates a first reference signal resource set; receives a first signaling, the first signaling being used for indicating a first time-frequency resource block; and transmits a first signal in the first time-frequency resource block when a first condition is satisfied; or, drops transmitting the first signal in the first time-frequency resource block when the first condition is unsatisfied. The first signaling is used for indicating a first index group; the first index group is used to determine a first reference signal resource from the first reference signal resource set; the first reference signal resource is used to determine a precoder of the first signal; the second signaling is used for indicating a first target reference signal resource.

### CROSS REFERENCE TO RELATED APPLICATIONS

This application claims is the continuation of the international pat. application No.PCT/CN2022/072872, filed on January 20,2022, and claims the priority benefit of Chinese Patent Application No.202110101278.8, filed on January 26,2021, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In New Radio (NR) R15 and R16, different beam management/indication mechanisms are respectively adopted for a control channel and a data channel, as well as for the uplink and the downlink. However, in many cases the control channel and the data channel can use the same beam, and since there exists channel reciprocity between an uplink channel and a downlink channel under many application scenarios, the same beam can be applicable to both channels. At the 3GPP Radio Access Network (RAN) 1 #103e conference, the technique of using physical layer signaling to update beams for the control channel and the data channel has been approved.

### SUMMARY

The applicant finds through researches that how a physical-layer signaling used for controlling beams for both a control channel and a data channel influences the consistency between a transmitting end and a receiving end is an issue for consideration.

To address the above problem, the present application provides a solution. It should be noted that although the statement above only took the example of cellular networks, the present application also applies to other scenarios like Vehicle-to-Everything (V2X), where similar technical effects can be achieved. Additionally, the adoption of a unified solution for various scenarios, including but not limited to cellular networks and V2X, contributes to the reduction of hardcore complexity and costs. In the case of no conflict, the embodiments of any node and the characteristics in the embodiments may be applied to any other node, and vice versa. What’s more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a second signaling and operating a first reference signal resource set;
receiving a first signaling, the first signaling being used for indicating a first time-frequency resource block; and
transmitting a first signal in the first time-frequency resource block when a first condition is satisfied; or, dropping transmitting the first signal in the first time-frequency resource block when the first condition is unsatisfied;
herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

In one embodiment, a problem to be solved in the present application includes: how a transmitting end determines whether to transmit a radio signal according to the beam update.

In one embodiment, a problem to be solved in the present application includes: how a transmitting end determines whether to transmit a radio signal of which a precoder is determined by the reference signal according to whether a reference signal resource is used for updating beams.

In one embodiment, a problem to be solved in the present application includes: for a PUSCH transmission, determining whether to transmit the PUSCH based on whether an SRS resource used to determine a precoder of the PUSCH is used for updating beams.

In one embodiment, a problem to be solved in the present application includes: for an SRS transmission, determining whether to transmit the SRS based on whether a CSI-RS resource used to determine a precoder of the SRS is used for updating beams.

In one embodiment, the essence of the above method lies in that a second signaling indicates beam update, a first reference signal resource set comprises an SRS resource set, and a first signal comprises a PUSCH, where a first reference signal resource is an SRS resource for determining a precoder of the PUSCH; whether the PUSCH is to be transmitted is determined based on whether the SRS resource is used for updating beams.

In one embodiment, the essence of the above method lies in that a second signaling indicates beam update, a first reference signal resource set comprises a CSI-RS resource set, and a first signal comprises an SRS, where a first reference signal resource is a CSI-RS resource for determining a precoder of the SRS; whether the SRS is to be transmitted is determined based on whether the CSI-RS resource is used for updating beams.

In one embodiment, an advantage of the above method includes: ensuring the consistency of the transmitting end and the receiving end with beams being updated.

In one embodiment, an advantage of the above method includes: ensuring the communication quality with beams being updated.

According to one aspect of the present application, characterized in that time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain.

According to one aspect of the present application, characterized in that a spatial-domain relation of a transmission of any reference signal resource in the first reference signal resource set that is earlier than the first time in time domain is unrelated to the first target reference signal resource.

According to one aspect of the present application, characterized in that time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

According to one aspect of the present application, characterized in that the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

According to one aspect of the present application, characterized in that the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources.

According to one aspect of the present application, characterized in that the first condition also comprises: the first target reference signal resource being used to determine a spatial-domain relation of a most recent transmission of each reference signal resource other than the first reference signal resource among the M1 reference signal resources.

The present application provides a method in a second node for wireless communications, comprising:
transmitting a second signaling and executing a first reference signal resource set;
transmitting a first signaling, the first signaling being used for indicating a first time-frequency resource block; and
monitoring a first signal in the first time-frequency resource block;
herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

According to one aspect of the present application, characterized in that time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain.

According to one aspect of the present application, characterized in that a spatial-domain relation of a transmission of any reference signal resource in the first reference signal resource set that is earlier than the first time in time domain is unrelated to the first target reference signal resource.

According to one aspect of the present application, characterized in that time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

According to one aspect of the present application, characterized in that the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

According to one aspect of the present application, characterized in that the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources.

According to one aspect of the present application, characterized in that the first condition also comprises: the first target reference signal resource being used to determine a spatial-domain relation of a most recent transmission of each reference signal resource other than the first reference signal resource among the M1 reference signal resources.

The present application provides a first node for wireless communications, comprising:
a first receiver, receiving a second signaling; and receiving a first signaling, the first signaling being used for indicating a first time-frequency resource block; and
a first transceiver, operating a first reference signal resource set; and
a first transmitter, transmitting a first signal in the first time-frequency resource block when a first condition is satisfied; or, dropping transmitting the first signal in the first time-frequency resource block when the first condition is unsatisfied;
herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

The present application provides a second node for wireless communications, comprising:
a second transmitter, transmitting a second signaling; and transmitting a first signaling, the first signaling being used for indicating a first time-frequency resource block; and
a second transceiver, executing a first reference signal resource set; and
a second receiver, monitoring a first signal in the first time-frequency resource block;
herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

In one embodiment, compared with the prior art, the present application is advantageous in the following aspects:
ensuring the consistency of the transmitting end and the receiving end with beams being updated;
ensuring the communication quality with beams being updated.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a second signaling, a first reference signal resource set, a first signaling, and a first signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission according to one embodiment of the present application.

FIG. 6 illustrates a schematic diagram of a second signaling being used to indicate a first target reference signal resource according to one embodiment of the present application.

FIG. 7 illustrates a schematic diagram of a first condition according to one embodiment of the present application.

FIG. 8 illustrates a schematic diagram of a first condition according to another embodiment of the present application.

FIG. 9 illustrates a schematic diagram of a first reference signal resource set according to one embodiment of the present application.

FIG. 10 illustrates a schematic diagram of a first reference signal resource set according to another embodiment of the present application.

FIG. 11 illustrates a schematic diagram of a first target reference signal resource according to one embodiment of the present application.

FIG. 12 illustrates a schematic diagram of a first target reference signal resource according to one embodiment of the present application.

FIG. 13 illustrates a schematic diagram of determining whether a first condition is satisfied according to one embodiment of the present application.

FIG. 14 illustrates a schematic diagram of a most recent transmission of a first reference signal resource according to one embodiment of the present application.

FIG. 15 illustrates a schematic diagram of a first index group being used to determine M1 reference signal resources from the first reference signal resource set according to one embodiment of the present application.

FIG. 16 illustrates a structure block diagram of a processing device in a first node according to one embodiment of the present application.

FIG. 17 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

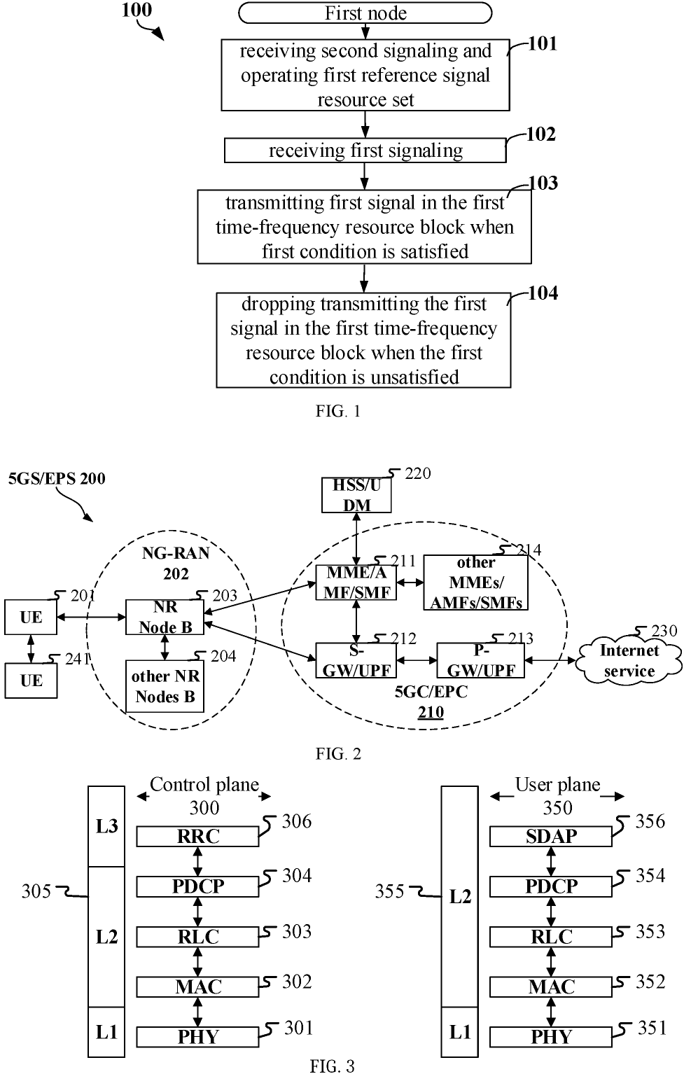

Embodiment 1 illustrates a flowchart of a second signaling, a first reference signal resource set, a first signaling, and a first signal according to one embodiment of the present application, as shown in FIG. 1. In 100 illustrated by FIG. 1, each box represents a step. Particularly, the sequential step arrangement in each box herein does not imply a chronological order of steps marked respectively by these boxes.

In Embodiment 1, the first node in the present application receives a second signaling and operates a first reference signal resource set in step 101; and receives a first signaling in step 102; and in step 103, transmits a first signal in the first time-frequency resource block when a first condition is satisfied; or in step 104, drops transmitting the first signal in the first time-frequency resource block when the first condition is unsatisfied; herein, the first signaling is used for indicating a first time-frequency resource block; and the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

In one embodiment, there is one reference signal resource in the first reference signal resource set of which a transmission is earlier than time-domain resources occupied by the second signaling in time domain.

In one embodiment, there is one reference signal resource in the first reference signal resource set of which a transmission is later than time-domain resources occupied by the second signaling in time domain.

In one embodiment, each reference signal resource in the first reference signal resource set is earlier than time-domain resources occupied by the second signaling in time domain.

In one embodiment, each reference signal resource in the first reference signal resource set is later than time-domain resources occupied by the second signaling in time domain.

### Embodiment 2

Embodiment 2 illustrates a schematic diagram of a network architecture according to one embodiment of the present application, as shown in FIG. 2.

FIG. 2 is a diagram illustrating a network architecture of Long-Term Evolution (LTE), Long-Term Evolution Advanced (LTE-A) and future 5G systems. The LTE, or LTE-A or future 5G network architecture 200 may be called an Evolved Packet System (EPS) 200. The 5G NR or LTE network 200 can be called a 5G System/Evolved Packet System (5GS/EPS)200 or other appropriate terms. The 5GS/EPS 200 may comprise one or more UEs 201, a UE 241 in sidelink communication with the UE(s) 201, an NG-RAN 202, a 5G CoreNetwork/Evolved Packet Core (5GC/EPC) 210, a Home Subscriber Server/ Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN202 comprises a New Radio (NR) node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning System (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/ Authentication Management Field (AMF)/ Session Management Function (SMF) 211, other MMEs/ AMFs/ SMFs 214, a Service Gateway (S-GW)/ User Plane Function (UPF) 212 and a Packet Date Network Gateway (P-GW)/UPF 213. The MME/ AMF/ SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the second node in the present application includes the UE 241.

In one embodiment, the second node in the present application includes the gNB203.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the second signaling is generated by the PHY 301, or the PHY 351.

In one embodiment, the first signaling is generated by the PHY 301, or the PHY 351.

In one embodiment, the first signaling is generated by the Radio Resource Control (RRC) sublayer 306.

In one embodiment, the first reference signal resource set is generated by the PHY 301, or the PHY 351.

In one embodiment, the first signal is generated by the PHY 301, or the PHY 351.

### Embodiment 4

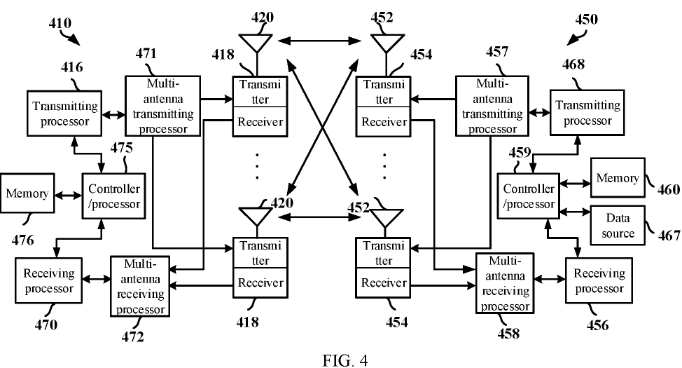

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any parallel stream targeting the second communication device 450. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives a second signaling and operates a first reference signal resource set; receives a first signaling, the first signaling being used for indicating a first time-frequency resource block; and transmits a first signal in the first time-frequency resource block when a first condition is satisfied; or, drops transmitting the first signal in the first time-frequency resource block when the first condition is unsatisfied; herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

In one embodiment, the second communication device 450 comprises a memory that stores a computer readable instruction program, the computer readable instruction program generates actions when executed by at least one processor, which include: receiving a second signaling and operating a first reference signal resource set; receiving a first signaling, the first signaling being used for indicating a first time-frequency resource block; and transmitting a first signal in the first time-frequency resource block when a first condition is satisfied; or, dropping transmitting the first signal in the first time-frequency resource block when the first condition is unsatisfied; herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a second signaling and executes a first reference signal resource set; transmits a first signaling, the first signaling being used for indicating a first time-frequency resource block; and monitors a first signal in the first time-frequency resource block; herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

In one embodiment, the first communication device 410 comprises a memory that stores a computer readable instruction program, the computer readable instruction program generates actions when executed by at least one processor, which include: transmitting a second signaling and executing a first reference signal resource set; transmitting a first signaling, the first signaling being used for indicating a first time-frequency resource block; and monitoring a first signal in the first time-frequency resource block; herein, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive the second signaling in the present application; at least one of the antenna 420, the transmitter 418, the transmitting processor 416, the multi-antenna transmitting processor 471, the controller/processor 475 or the memory 476 is used to transmit the second signaling in the present application.

In one embodiment, at least one of the antenna 452, the receiver 454, the receiving processor 456, the multi-antenna receiving processor 458, the controller/processor 459, the memory 460 or the data source 467 is used to receive the first signaling in the present application; at least one of the antenna 420, the transmitter 418, the transmitting processor 416, the multi-antenna transmitting processor 471, the controller/processor 475 or the memory 476 is used to transmit the first signaling in the present application.

In one embodiment, at least one of the antenna 452, the receiver 454, the receiving processor 456, the multi-antenna receiving processor 458, the controller/processor 459, the memory 460 or the data source 467 is used for operating the first reference signal resource set in the present application, where the operating is receiving; at least one of the antenna 420, the transmitter 418, the transmitting processor 416, the multi-antenna transmitting processor 471, the controller/processor 475 or the memory 476 is used for executing the first reference signal resource set in the present application, where the executing is transmitting.

In one embodiment, at least one of the antenna 452, the transmitter 454, the transmitting processor 468, the multi-antenna transmitting processor 457, the controller/processor 459 or the memory 460 is used for operating the first reference signal resource set in the present application, where the operating is transmitting; at least one of the antenna 420, the receiver 418, the receiving processor 470, the multi-antenna receiving processor 472, the controller/processor 475 or the memory 476 is used for executing the first reference signal resource set in the present application, where the executing is receiving.

In one embodiment, at least one of the antenna 452, the transmitter 454, the transmitting processor 468, the multi-antenna transmitting processor 457, the controller/processor 459 or the memory 460 is used to transmit the first signal in the first time-frequency resource block in the present application.

In one embodiment, at least one of the antenna 452, the transmitter 454, the transmitting processor 468, the multi-antenna transmitting processor 457, the controller/processor 459 or the memory 460 is used to drop transmitting the first signal in the first time-frequency resource block in the present application.

In one embodiment, at least one of the antenna 420, the receiver 418, the receiving processor 470, the multi-antenna receiving processor 472, the controller/processor 475 or the memory 476 is used to monitor the first signal in the first time-frequency resource block in the present application.

### Embodiment 5

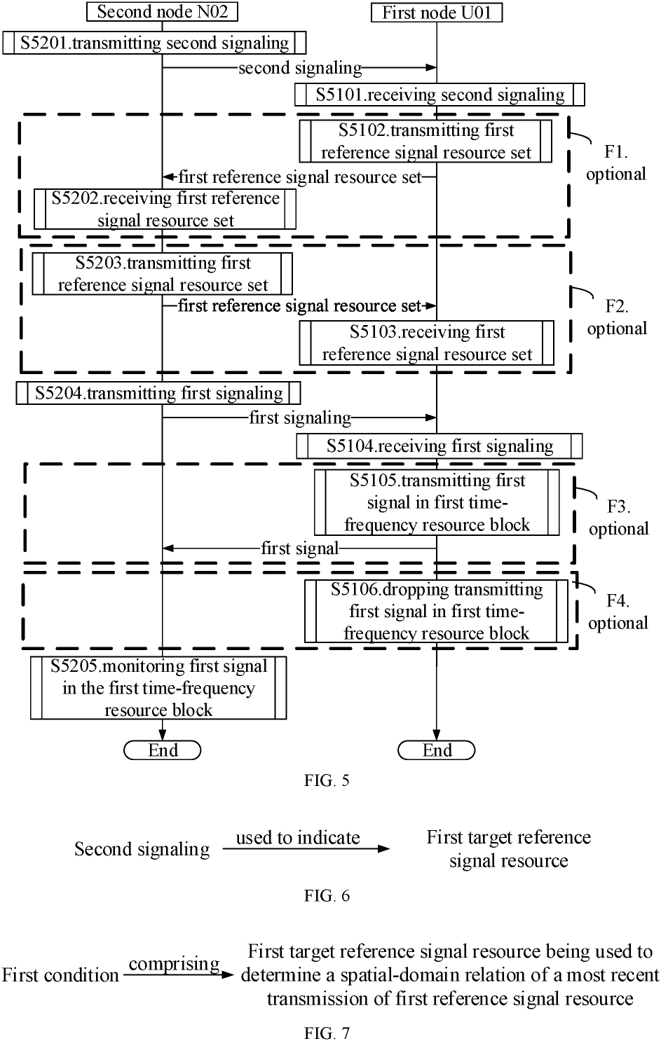

Embodiment 5 illustrates a flowchart of wireless transmission according to one embodiment of the present application, as shown in FIG. 5. In FIG. 5, a first node U01 and a second node N02 are respectively two communication nodes that transmit via an air interface. In FIG. 5, there is one and only optional box between the boxes F1 and F2, and there is one and only optional box between the boxes F3 and F4.

The first node U01 receives a second signaling in step S5101; transmits a first reference signal resource set in step S5102; and receives a first reference signal resource set in step S5103; and receives a first signaling in step S5104; and transmits a first signal in a first time-frequency resource block in step S5105; or drops transmitting the first signal in the first time-frequency resource block in step S5106.

The second node N02 transmits a second signaling in step S5201; and receives a first reference signal resource set in step S5202; and transmits a first reference signal resource set in step S5203; and transmits a first signaling in step S5204; and monitors a first signal in the first time-frequency resource block in step S5205.

In Embodiment 5, the first signaling is used for indicating a first time-frequency resource block; the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used by the first node U01 to determine a precoder of the first signal; the second signaling is used for indicating a first target reference signal resource; the first condition comprises: the first target reference signal resource being used by the first node U01 to determine a spatial-domain relation of a most recent transmission of the first reference signal resource; the operating is transmitting, or, the operating is receiving.

In one embodiment, the operating in the present application is transmitting and the executing is receiving, with the presence of the box F1.

In one embodiment, the operating in the present application is receiving and the executing is transmitting, with the presence of the box F2.

In one embodiment, the first node U01 transmits a first signal in the first time-frequency resource block when a first condition is satisfied; or, the first node U01 drops transmitting the first signal in the first time-frequency resource block when the first condition is unsatisfied.

In one embodiment, the second node N02 monitors a first signal in the first time-frequency resource block when a first condition is satisfied.

In one embodiment, the second node N02 monitors a first signal in the first time-frequency resource block when a first condition is unsatisfied.

In one embodiment, the second node N02 does not monitor a first signal in the first time-frequency resource block when a first condition is unsatisfied.

In one embodiment, the second node N02 receives a first signal in the first time-frequency resource block when a first condition is satisfied.

In one embodiment, when the first condition is unsatisfied, the second node N02 drops receiving the first signal in the first time-frequency resource block.

In one embodiment, when the first condition is unsatisfied, the second node N02 itself determines whether to receive the first signal in the first time-frequency resource block.

In one embodiment, the monitoring refers to coherent reception, that is, to perform coherent reception and measure energy of a signal obtained by the coherent reception; if the energy of the signal obtained by the coherent reception is larger than a first given threshold, it is determined that the first signal is received; otherwise, it is determined that the first signal is not received.

In one embodiment, the monitoring refers to reception based on energy detection, that is, to sense energies of radio signals and average to obtain a received energy; if the received energy is larger than a second given threshold, it is determined that the first signal is received; otherwise, it is determined that the first signal is not received.

In one embodiment, the monitoring refers to Blind Decoding, that is, to receive a signal and perform decoding operation; if the decoding is determined as correct according to a Cyclic Redundancy Check (CRC) bit, it is determined that the first signal is received; otherwise, it is determined that the first signal is not received.

In one embodiment, the monitoring includes reception.

In one embodiment, the first reference signal resource set comprises at least one reference signal resource.

In one embodiment, the first reference signal resource set only comprises one reference signal resource.

In one embodiment, the first reference signal resource set comprises multiple reference signal resources.

In one embodiment, the first reference signal resource set comprises an SS/PBCH block.

In one embodiment, the first reference signal resource set comprises at least one of a CSI-RS resource, an SS/PBCH block or an SRS resource.

In one embodiment, the first reference signal resource set comprises at least one of a CSI-RS resource or an SRS resource.

In one embodiment, the first reference signal resource set comprises a CSI-RS resource or an SRS resource.

In one embodiment, any reference signal resource in the first reference signal resource set is a CSI-RS resource or an SRS resource.

In one embodiment, the method in the first node comprises:
receiving a second information block;
herein, the second information block is used to indicate the first reference signal resource set.

In one embodiment, the first receiver receives a second information block; herein, the second information block is used to indicate the first reference signal resource set.

In one embodiment, the method in the second node comprises:
transmitting a second information block;
herein, the second information block is used to indicate the first reference signal resource set.

In one embodiment, the second transmitter transmits a second information block; herein, the second information block is used to indicate the first reference signal resource set.

In one embodiment, the second information block explicitly indicates the first reference signal resource set.

In one embodiment, the second information block implicitly indicates the first reference signal resource set.

In one embodiment, the second information block is borne by a higher layer signaling.

In one embodiment, the second information block is borne by an RRC signaling.

In one embodiment, the second information block is borne by a MAC CE signaling.

In one embodiment, the second information block comprises multiple Information Elements (IEs) in an RRC signaling.

In one embodiment, the second information block comprises one IE in an RRC signaling.

In one embodiment, the second information block comprises partial fields in one IE in an RRC signaling.

### Embodiment 6

Embodiment 6 illustrates a schematic diagram of a second signaling being used to indicate a first target reference signal resource according to one embodiment of the present application; as shown in FIG. 6.

In one embodiment, the second signaling is a physical layer signaling.

In one embodiment, the second signaling is a piece of Downlink Control Information (DCI).

In one embodiment, the second signaling comprises a DCI for DownLink Grant.

In one embodiment, the second signaling comprises a DCI for UpLink Grant.

In one embodiment, the second signaling explicitly indicates a first target reference signal resource.

In one embodiment, the second signaling implicitly indicates a first target reference signal resource.

In one embodiment, the second signaling indicates the first target reference signal resource.

In one embodiment, the second signaling indicates an index of the first target reference signal resource.

In one embodiment, the second signaling indicates a first Transmission Configuration Indicator (TCI) state, the first TCI state indicating the first target reference signal resource.

In one embodiment, the second signaling indicates a first TCI state in N TCI states, the first TCI state indicating the first target reference signal resource, where N is a positive integer greater than 1.

In one embodiment, the second signaling indicates a TCI codepoint corresponding to the first TCI state.

In one embodiment, the second signaling comprises a first field, the first field comprising at least one bit; the first field in the second signaling indicates the first target reference signal resource.

In one embodiment, the first field in the second signaling indicates the first TCI state.

In one embodiment, a value of the first field in the second signaling is equal to a TCI codepoint corresponding to the first TCI state.

In one embodiment, the first field comprises 3 bits.

In one embodiment, the first field comprises a Transmission configuration indication field.

In one embodiment, the first field comprises an SRS resource indicator field.

In one embodiment, the definition of the Transmission configuration indication field can be found in 3GPP TS38.212, section 7.3.

In one embodiment, the definition of the SRS resource indicator field can be found in 3GPP TS38.212, section 7.3.

In one embodiment, the first target reference signal resource comprises a Channel State Information-Reference Signal (CSI-RS) resource.

In one embodiment, the first target reference signal resource comprises a Non-Zero Power (NZP) CSI-RS resource.

In one embodiment, the first target reference signal resource comprises a Synchronisation Signal/physical broadcast channel Block (SSB) resource.

In one embodiment, the first target reference signal resource comprises a Sounding Reference Signal (SRS) resource.

In one embodiment, the first target reference signal resource is a CSI-RS resource or an SSB resource.

In one embodiment, the first target reference signal resource is one of a CSI-RS resource, an SSB resource or an SRS resource.

In one embodiment, an index of the first target reference signal resource includes a NZP-CSI-RS-ResourceId.

In one embodiment, an index of the first target reference signal resource includes a NZP-CSI-RS-ResourceSetId.

In one embodiment, an index of the first target reference signal resource includes an SSB-Index.

In one embodiment, an index of the first target reference signal resource includes an SRS-ResourceSetId.

In one embodiment, an index of the first target reference signal resource includes an SRS-ResourceId.

In one embodiment, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain.

In one embodiment, time-domain resources occupied by the second signaling are used to determine a first time; the first target reference signal resource is used to determine a spatial-domain relation of an uplink physical-layer data channel and a spatial-domain relation of an uplink physical-layer control channel transmitted after the first time.

In one embodiment, the uplink physical-layer control channel is a Physical Uplink Control Channel (PUCCH).

In one embodiment, the uplink physical-layer control channel is a short PUCCH (sPUCCH).

In one embodiment, the uplink physical-layer control channel is a Narrow Band PUCCH (NB-PUCCH).

In one embodiment, a second target reference signal resource is used to determine a spatial-domain relation of an uplink physical-layer data channel and a spatial-domain relation of an uplink physical-layer control channel transmitted before the first time.

In one embodiment, a reference signal resource used to determine a spatial-domain relation of an uplink physical-layer data channel and a spatial-domain relation of an uplink physical-layer control channel transmitted before the first time is different from the first target reference signal resource.

In one embodiment, a reference signal resource used to determine a spatial-domain relation of an uplink physical-layer data channel and a spatial-domain relation of an uplink physical-layer control channel transmitted before the first time is non-QCL with the first target reference signal resource.

In one embodiment, the QCL refers to being Quasi-Co-Located.

In one embodiment, the QCL refers to Quasi-Co-Location.

In one embodiment, the QCL includes QCL Type-A.

In one embodiment, the QCL includes QCL Type-B.

In one embodiment, the QCL includes QCL Type-C.

In one embodiment, the QCL includes QCL Type-D.

In one embodiment, the QCL parameter includes one or more of a delay spread, a Doppler spread, a Doppler shift, an average delay or a Spatial Rx parameter.

In one embodiment, a spatial-domain filter for a reference signal resource used to determine a spatial-domain relation of an uplink physical-layer data channel and a spatial-domain relation of an uplink physical-layer control channel transmitted before the first time is different from a spatial-domain filter for the first target reference signal resource.

In one embodiment, the second target reference signal resource is different from the first target reference signal resource.

In one embodiment, the second target reference signal resource and the first target reference signal resource are non-QCL.

In one embodiment, a spatial-domain filter for the second target reference signal resource is different from a spatial-domain filter for the first target reference signal resource.

In one embodiment, a spatial-domain relation of an uplink physical-layer data channel and a spatial-domain relation of an uplink physical-layer control channel transmitted before the first time are different from the first target reference signal resource.

In one embodiment, the first signaling comprises the first field, which is not used for indicating a spatial-domain relation of the first signal.

In one embodiment, the first signaling and the second signaling are respectively two signalings.

In one embodiment, the first signaling does not indicate a spatial-domain relation of the first signal.

In one embodiment, a spatial-domain relation of the first signal is related to only the second signaling of the first signaling and the second signaling.

In one embodiment, the first signaling comprises the first field, the first field in the first signaling being unrelated to the second signal.

In one embodiment, the first signaling comprises the first field, where a value of the first field in the first signaling is identical to a value of the first field in the second signaling.

### Embodiment 7

Embodiment 7 illustrates a schematic diagram of a first condition according to one embodiment of the present application; as shown in FIG. 7.

In Embodiment 7, the first condition comprises: the first target reference signal resource being used to determine a spatial-domain relation of a most recent transmission of the first reference signal resource.

In one embodiment, transmitting a first signal in the first time-frequency resource block when a first condition is satisfied; and, dropping transmitting the first signal in the first time-frequency resource block when the first condition is unsatisfied.

In one embodiment, when the first target reference signal resource is used to determine a spatial-domain relation of a most recent transmission of the first reference signal resource, the first condition is satisfied.

In one embodiment, whether the first condition is satisfied is used to determine whether the first signal is to be transmitted.

In one embodiment, the first condition comprises multiple sub-conditions, where a first sub-condition is a sub-condition in the first condition; the first sub-condition comprises: the first target reference signal resource being used to determine a spatial-domain relation of a most recent transmission of the first reference signal resource.

In one embodiment, the first condition comprises multiple sub-conditions; when each sub-condition in the first condition is satisfied, the first condition is satisfied; when there is one sub-condition being unsatisfied in the first condition, the first condition is unsatisfied.

In one embodiment, the first condition comprises multiple sub-conditions; when there is one sub-condition being satisfied in the first condition, the first condition is satisfied; when each sub-condition in the first condition is not satisfied, the first condition is unsatisfied.

In one embodiment, the first condition comprises multiple sub-conditions; the phrase that “the first condition is satisfied” means that each sub-condition in the first condition is satisfied; the phrase that “the first condition is unsatisfied” means that there is one sub-condition in the first condition being not satisfied.

In one embodiment, the first condition comprises multiple sub-conditions; the phrase that “the first condition is satisfied” means that there is one sub-condition in the first condition being satisfied; the phrase that “the first condition is unsatisfied” means that each sub-condition in the first condition is unsatisfied.

In one embodiment, whether the first condition is satisfied is used to determine whether a first signal is to be transmitted in the first time-frequency resource block.

In one embodiment, the first condition is that the first target reference signal resource being used to determine a spatial-domain relation of a most recent transmission of the first reference signal resource.

In one embodiment, when the first target reference signal resource is used to determine a spatial-domain relation of a most recent transmission of the first reference signal resource, the first condition is satisfied; when the spatial-domain relation of the most recent transmission of the first reference signal resource is unrelated to the first target reference signal resource, the first condition is not satisfied.

In one embodiment, when the first target reference signal resource is used to determine a spatial-domain relation of a most recent transmission of the first reference signal resource, the first sub-condition is satisfied; when the spatial-domain relation of the most recent transmission of the first reference signal resource is unrelated to the first target reference signal resource, the first sub-condition is not satisfied.

In one embodiment, the phrase that “the spatial-domain relation of the most recent transmission of the first reference signal resource is unrelated to the first target reference signal resource” includes a meaning that: the first target reference signal resource is not used to determine the spatial-domain relation of a most recent transmission of the first reference signal resource.

In one embodiment, the phrase that “the spatial-domain relation of the most recent transmission of the first reference signal resource is unrelated to the first target reference signal resource” includes a meaning that: a first Transmission Configuration Indicator (TCI) state indicates the first target reference signal resource, while a second TCI state is used to determine a spatial-domain relation of a most recent transmission of the first reference signal resource, where the first TCI state is different from the second TCI state.

In one embodiment, the phrase that “the spatial-domain relation of the most recent transmission of the first reference signal resource is unrelated to the first target reference signal resource” includes a meaning that: a spatial-domain relation of a most recent transmission of the first reference signal resource is different from a spatial domain filter of the first target reference signal resource.

In one embodiment, the phrase that “the spatial-domain relation of the most recent transmission of the first reference signal resource is unrelated to the first target reference signal resource” includes a meaning that: a spatial-domain relation of a most recent transmission of the first reference signal resource is different from a spatial-domain relation of the first target reference signal resource.

In one embodiment, the phrase that “the spatial-domain relation of the most recent transmission of the first reference signal resource is unrelated to the first target reference signal resource” includes a meaning that: a third target reference signal resource is used to determine a spatial-domain relation of a most recent transmission of the first reference signal resource, where the third target reference signal resource is different from the first target reference signal resource.

In one embodiment, the phrase that “the spatial-domain relation of the most recent transmission of the first reference signal resource is unrelated to the first target reference signal resource” includes a meaning that: a third target reference signal resource is used to determine a spatial-domain relation of a most recent transmission of the first reference signal resource, where the third target reference signal resource is non-QCL with the first target reference signal resource.

In one embodiment, the phrase that “the spatial-domain relation of the most recent transmission of the first reference signal resource is unrelated to the first target reference signal resource” includes a meaning that: a third target reference signal resource is used to determine a spatial-domain relation of a most recent transmission of the first reference signal resource, where a spatial domain filter for the third target reference signal resource is different from that for the first target reference signal resource.

In one embodiment, a spatial-domain relation of a transmission is used for transmitting the transmission.

In one embodiment, a spatial-domain relation of a transmission is used for receiving the transmission.

In one embodiment, a spatial-domain relation of a reference signal resource is used for transmitting the reference signal resource.

In one embodiment, a spatial-domain relation of a reference signal resource is used for receiving the reference signal resource.

In one embodiment, the spatial-domain relation comprises a Transmission Configuration Indicator (TCI) state.

In one embodiment, the third target reference signal resource comprises the second target reference signal resource.

In one embodiment, the third target reference signal resource is the second target reference signal resource.

In one embodiment, the third target reference signal resource is different from the second target reference signal resource.

In one embodiment, the spatial-domain relation comprises a Quasi co-location (QCL) parameter.

In one embodiment, the spatial-domain relation comprises a Spatial domain filter.

In one embodiment, the spatial-domain relation comprises a Spatial domain transmission filter.

In one embodiment, the spatial-domain relation comprises a Spatial domain reception filter.

In one embodiment, the spatial-domain relation comprises a Spatial domain transmission filter and a Spatial domain reception filter.

In one embodiment, the spatial-domain relation comprises Spatial parameters.

In one embodiment, the spatial parameter comprises a Spatial Tx parameter.

In one embodiment, the spatial parameter comprises a Spatial Rx parameter.

In one embodiment, the spatial parameter comprises a Spatial Tx parameter and a Spatial Rx parameter.

In one embodiment, the Spatial Tx parameters include one or more of a transmission antenna port, a transmission antenna port group, a transmission analog beamforming matrix, a transmission analog beamforming vector, a transmission beamforming matrix, a transmission beamforming vector or a spatial domain transmission filter.

In one embodiment, the Spatial Rx parameters include one or more of a receiving beam, a reception analog beamforming matrix, a reception analog beamforming vector, a reception beamforming matrix, a reception beamforming vector or a spatial domain reception filter.

In one embodiment, the spatial domain filter includes a spatial domain transmission filter.

In one embodiment, the spatial domain filter includes a spatial domain reception filter.

In one embodiment, the spatial domain filter includes a spatial domain transmission filter and a spatial domain reception filter.

In one embodiment, a given reference signal resource is an uplink reference signal resource, and a spatial domain filter for the given reference signal resource includes a spatial domain transmission filter for the given reference signal resource.

In one embodiment, a given reference signal resource is a downlink reference signal resource, and a spatial domain filter for the given reference signal resource includes a spatial domain reception filter for the given reference signal resource.

In one embodiment, spatial domain filters for a given reference signal resource include a spatial domain transmission filter and a spatial domain reception filter for the given reference signal resource.

In one embodiment, the downlink reference signal resource comprises at least one of a Channel State Information-Reference Signal (CSI-RS) resource or a Synchronization Signal/Physical Broadcast CHannel (SS/PBCH) Block.

In one embodiment, the downlink reference signal resource comprises a CSI-RS resource and an SS/PBCH Block.

In one embodiment, the downlink reference signal resource comprises a CSI-RS resource.

In one embodiment, the uplink reference signal resource comprises a Sounding Reference Signal (SRS) resource.

In one embodiment, the uplink reference signal resource comprises at least one of a Sounding Reference Signal (SRS) resource, a DMRS or a PTRS resource.

In one embodiment, when the first signal is transmitted in the first time-frequency resource block, the first target reference signal resource is used to determine a spatial-domain relation of the first signal.

In one embodiment, the sentence that “dropping transmitting the first signal in the first time-frequency resource block when the first condition is unsatisfied” means: maintaining a zero-transmit-power in the first time-frequency resource block.

In one embodiment, the sentence that “dropping transmitting the first signal in the first time-frequency resource block when the first condition is unsatisfied” means: transmitting a signal unrelated to the first signal in the first time-frequency resource block.

In one embodiment, the sentence that “dropping transmitting the first signal in the first time-frequency resource block when the first condition is unsatisfied” means: transmitting of the first signal being dropped.

In one embodiment, the sentence that “dropping transmitting the first signal in the first time-frequency resource block when the first condition is unsatisfied” means: dropping generation of the first signal.

In one embodiment, the sentence that “dropping transmitting the first signal in the first time-frequency resource block when the first condition is unsatisfied” means: dropping generation of a modulation symbol of the first signal.

In one embodiment, the sentence that “dropping transmitting the first signal in the first time-frequency resource block when the first condition is unsatisfied” means: a modulation symbol generated for the first signal being dropped.

In one embodiment, the sentence that “dropping transmitting the first signal in the first time-frequency resource block when the first condition is unsatisfied” means: transmitting of a modulation symbol generated for the first signal being postponed.

In one embodiment, the sentence that “dropping transmitting the first signal in the first time-frequency resource block when the first condition is unsatisfied” means: a modulation symbol generated for the first signal being transmitted in time-frequency resources orthogonal with the first time-frequency resource block.

In one embodiment, a given reference signal resource is used to determine a spatial-domain relation of a given signal.

In one subembodiment, the given reference signal resource is a downlink reference signal resource.

In one subembodiment, the given reference signal resource is an uplink reference signal resource.

In one subembodiment, the given reference signal resource is the first reference signal resource.

In one subembodiment, the given reference signal resource is the M1 reference signal resources.

In one subembodiment, the given reference signal resource is the first target reference signal resource.

In one subembodiment, the given reference signal resource is the third target reference signal resource.

In one subembodiment, the given reference signal resource is the second target reference signal resource.

In one subembodiment, the given signal is a most recent transmission of the first reference signal resource.

In one subembodiment, the given signal is the first signal.

In one subembodiment, the given signal is a transmission of any reference signal resource in the first reference signal resource set that is no earlier than the first time in time domain.

In one subembodiment, the given signal is a transmission of any reference signal resource in the first reference signal resource set that is later than the first time in time domain.

In one subembodiment, the given signal is at least one transmission of at least one reference signal resource in the first reference signal resource set.

In one subembodiment, the given signal is a transmission of one reference signal resource in the first reference signal resource set.

In one subembodiment, the given signal is a most recent transmission of any reference signal resource other than the first reference signal resource among the M1 reference signal resources.

In one subembodiment, a TCI state of the given reference signal resource is used to determine a spatial-domain relation of the given signal.

In one subembodiment, the spatial-domain relation comprises a TCI state, where a TCI state of the given reference signal resource is identical to a TCI state of the given signal.

In one subembodiment, a QCL parameter of the given reference signal resource is used to determine a spatial-domain relation of the given signal.

In one subembodiment, the spatial-domain relation comprises a QCL parameter, where a QCL parameter of the given reference signal resource is identical to a QCL parameter of the given signal.

In one subembodiment, a spatial domain filter of the given reference signal resource is used to determine a spatial-domain relation of the given signal.

In one subembodiment, the spatial-domain relation comprises a spatial domain filter, where a spatial domain filter of the given reference signal resource is identical to a spatial domain filter of the given signal.

In one subembodiment, the spatial-domain relation comprises a spatial domain transmission filter, and the given reference signal resource is an uplink signal, where a spatial domain transmission filter of the given reference signal resource is identical to a spatial domain transmission filter of the given signal.

In one subembodiment, the spatial-domain relation comprises a spatial domain transmission filter, and the given reference signal resource is a downlink signal, where a spatial domain reception filter of the given reference signal resource is identical to a spatial domain transmission filter of the given signal.

In one subembodiment, the spatial-domain relation comprises a spatial domain reception filter, and the given reference signal resource is an uplink signal, where a spatial domain reception filter of the given reference signal resource is identical to a spatial domain reception filter of the given signal.

In one subembodiment, the spatial-domain relation comprises a spatial domain reception filter, and the given reference signal resource is a downlink signal, where a spatial domain transmission filter of the given reference signal resource is identical to a spatial domain reception filter of the given signal.

In one subembodiment, a spatial parameter of the given reference signal resource is used to determine a spatial-domain relation of the given signal.

In one subembodiment, the spatial-domain relation comprises spatial transmission parameters, where a spatial parameter of the given reference signal resource is identical to a spatial transmission parameter of the given signal.

In one subembodiment, the spatial-domain relation comprises spatial transmission parameters, and the given reference signal resource is an uplink signal, where a spatial transmission parameter of the given reference signal resource is identical to a spatial transmission parameter of the given signal.

In one subembodiment, the spatial-domain relation comprises spatial transmission parameters, and the given reference signal resource is a downlink signal, where a spatial reception parameter of the given reference signal resource is identical to a spatial transmission parameter of the given signal.

In one subembodiment, the spatial-domain relation comprises spatial reception parameters, where a spatial parameter of the given reference signal resource is identical to a spatial reception parameter of the given signal.

In one subembodiment, the spatial-domain relation comprises spatial reception parameters, and the given reference signal resource is an uplink signal, where a spatial reception parameter of the given reference signal resource is identical to a spatial reception parameter of the given signal.

In one subembodiment, the spatial-domain relation comprises spatial reception parameters, and the given reference signal resource is a downlink signal, where a spatial transmission parameter of the given reference signal resource is identical to a spatial reception parameter of the given signal.

### Embodiment 8

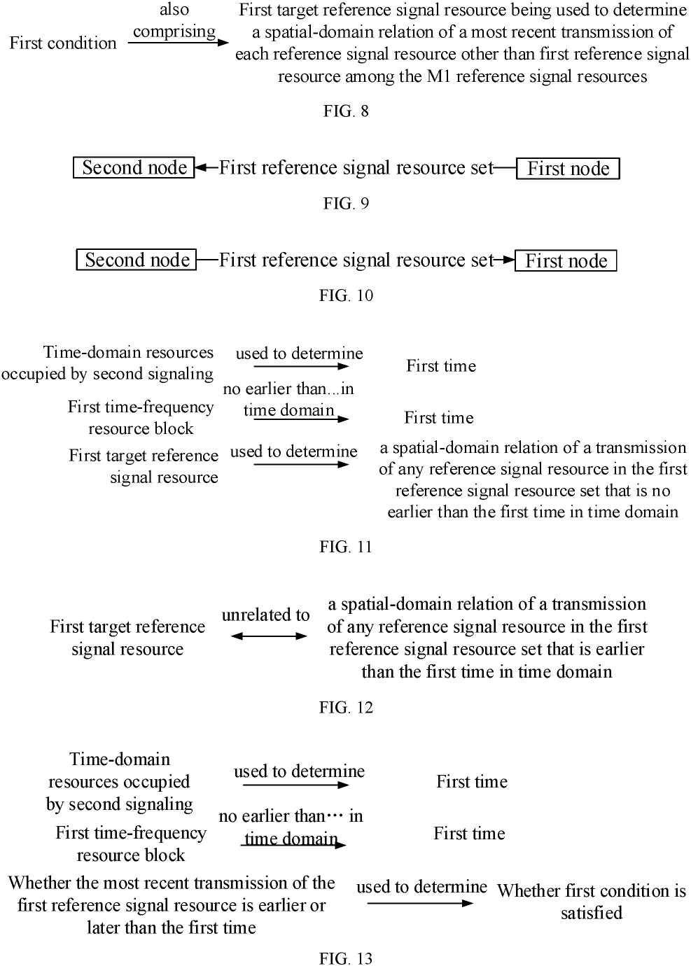

Embodiment 8 illustrates a schematic diagram of a first condition according to another embodiment of the present application; as shown in FIG. 8.

In Embodiment 8, the first condition also comprises: the first target reference signal resource being used to determine a spatial-domain relation of a most recent transmission of each reference signal resource other than the first reference signal resource among the M1 reference signal resources.

In one embodiment, the first condition comprises: the first target reference signal resource being used to determine a spatial-domain relation of a most recent transmission of each reference signal resource among the M1 reference signal resources.

In one embodiment, when the first target reference signal resource is used to determine a spatial-domain relation of a most recent transmission of each reference signal resource among the M1 reference signal resources, the first condition is satisfied.

In one embodiment, the first condition comprises: a given reference signal resource being any reference signal resource among the M1 reference signal resources, where the first target reference signal resource is used to determine a spatial-domain relation of a most recent transmission of the given reference signal resource.

In one embodiment, the first condition comprises multiple sub-conditions; the second sub-condition comprises: the first target reference signal resource being used to determine a spatial-domain relation of a most recent transmission of each reference signal resource other than the first reference signal resource among the M1 reference signal resources.

In one embodiment, when the first sub-condition and the second sub-condition are both satisfied, the first condition is satisfied; when at least one of the first sub-condition or the second sub-condition is not satisfied, the first condition is unsatisfied.

In one embodiment, when the first target reference signal resource is used to determine a spatial-domain relation of a most recent transmission of each reference signal resource other than the first reference signal resource among the M1 reference signal resources, the second sub-condition is satisfied.

In one embodiment, when the first target reference signal resource is not used to determine a spatial-domain relation of a most recent transmission of one reference signal resource other than the first reference signal resource among the M1 reference signal resources, the second sub-condition is not satisfied.

In one embodiment, when the first target reference signal resource is unrelated to a spatial-domain relation of a most recent transmission of one reference signal resource other than the first reference signal resource among the M1 reference signal resources, the second sub-condition is not satisfied.

In one embodiment, a given reference signal resource is any reference signal resource among the M1 reference signal resources, and the given reference signal resource comprises multiple transmissions, where the most recent transmission of the given reference signal resource is a transmission no later than and closest to a second time in time that is among the multiple transmissions of the given reference signal resource.

In one embodiment, a given reference signal resource is any reference signal resource among the M1 reference signal resources, and the given reference signal resource comprises multiple transmissions, where the most recent transmission of the given reference signal resource is a transmission earlier than and closest to a second time in time that is among the multiple transmissions of the given reference signal resource.

In one embodiment, a given reference signal resource is any reference signal resource among the M1 reference signal resources, and the given reference signal resource comprises multiple transmissions, where the most recent transmission of the given reference signal resource is a transmission earlier than and closest to a second time in time that is among the multiple transmissions of the given reference signal resource.

In one embodiment, a given reference signal resource is any reference signal resource among the M1 reference signal resources, and the given reference signal resource comprises multiple transmissions, where the most recent transmission of the given reference signal resource is a transmission of which a corresponding start time is no later than and closest to a second time in time among the multiple transmissions of the given reference signal resource.

In one embodiment, a given reference signal resource is any reference signal resource among the M1 reference signal resources, and the given reference signal resource comprises multiple transmissions, where the most recent transmission of the given reference signal resource is a transmission of which a corresponding start time is no later than and closest to a second time in time among the multiple transmissions of the given reference signal resource.

In one embodiment, time-domain resources occupied by the second signaling are used to determine a first time; the first time-frequency resource block is no earlier than the first time in time domain; whether a most recent transmission of each reference signal resource among the M1 reference signal resources is earlier or later than the first time is used to determine whether the first condition is satisfied.

In one embodiment, when a most recent transmission of each reference signal resource among the M1 reference signal resources is no earlier than the first time in time domain, the first condition is satisfied.

In one embodiment, when a most recent transmission of each reference signal resource among the M1 reference signal resources is later than the first time in time domain, the first condition is satisfied.

In one embodiment, when there exists one reference signal resource among the M1 reference signal resources of which a most recent transmission is earlier than the first time in time domain, the first condition is not satisfied.

### Embodiment 9

Embodiment 9 illustrates a schematic diagram of a first reference signal resource set according to one embodiment of the present application; as shown in FIG. 9.

In Embodiment 9, the operating in the present application is transmitting, and the executing in the present application is receiving; the first node transmits a first reference signal resource set, while the second node receives the first reference signal resource set.

In one embodiment, the operating is transmitting, and the executing is receiving.

In one embodiment, the first reference signal resource set comprises SRS resources.

In one embodiment, any reference signal resource in the first reference signal resource set is an SRS resource.

In one embodiment, the first reference signal resource set is identified by an SRS-ResourceSetId.

In one embodiment, the first signal comprises a baseband signal.

In one embodiment, the first signal comprises a radio signal.

In one embodiment, the first signal comprises a radio frequency signal.

In one embodiment, the first signal comprises a PUSCH.

In one embodiment, the first signal is transmitted on an uplink physical layer data channel (i.e., an uplink channel capable of bearing physical layer data).

In one embodiment, the first signal carries a first bit block.

In one embodiment, the first signal comprises a repetition of transmission of a first bit block.

In one embodiment, a first bit block is used for generating the first signal.

In one embodiment, the first bit block comprises a Transport Block (TB).

In one embodiment, the first bit block comprises at least one TB.

In one embodiment, the first bit block comprises at least one Code Block Group (CBG).

In one embodiment, the first signal is obtained by the first bit block sequentially through CRC Insertion, Channel Coding, Rate Matching, Scrambling, Modulation, Layer Mapping, Precoding, Mapping to Resource Element, OFDM Baseband Signal Generation, and Modulation and Upconversion.

In one embodiment, the first signal is obtained by the first bit block sequentially through CRC Insertion, Channel Coding, Rate Matching, Scrambling, Modulation, Layer Mapping, Precoding, Mapping to Virtual Resource Blocks, Mapping from Virtual to Physical Resource Blocks, OFDM Baseband Signal Generation, and Modulation and Upconversion.

In one embodiment, the first signal is obtained by the first bit block sequentially through CRC Insertion, Segmentation, Code Block (CB)-level CRC Insertion, Channel Coding, Rate Matching, Concatenation, Scrambling, Modulation, Layer Mapping, Precoding, Mapping to Resource Element, OFDM Baseband Signal Generation, and Modulation and Upconversion.

In one embodiment, the first time-frequency resource block comprises a positive integer number of Resource Element(s) (RE(s)).

In one embodiment, time-domain resources occupied by the first time-frequency resource block comprise a positive integer number of symbol(s).

In one embodiment, frequency-domain resources occupied by the first time-frequency resource block comprise a positive integer number of Resource Block(s) (RB(s)).

In one embodiment, frequency-domain resources occupied by the first time-frequency resource block comprise a positive integer number of subcarrier(s).

In one embodiment, the symbol is a single-carrier symbol.

In one embodiment, the symbol is a multi-carrier symbol.

In one embodiment, the multicarrier symbol is an Orthogonal Frequency Division Multiplexing (OFDM) Symbol.

In one embodiment, the multicarrier symbol is a Single Carrier- Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multi Carrier (FBMC) symbol.

In one embodiment, the multicarrier symbol comprises a Cyclic Prefix (CP).

In one embodiment, the first signaling explicitly indicates the first time-frequency resource block.

In one embodiment, the first signaling implicitly indicates the first time-frequency resource block.

In one embodiment, the first signaling indicates time-domain resources occupied by the first time-frequency resource block and frequency-domain resources occupied by the first time-frequency resource block.

In one embodiment, the first signaling comprises a first field and a second field, where the first field in the first signaling indicates time-domain resources occupied by the first time-frequency resource block, while the second field in the first signaling indicates frequency-domain resources occupied by the first time-frequency resource block; the first field comprises a positive integer number of bit(s), and the second field comprises a positive integer number of bit(s).

In one embodiment, the first field is a Time domain resource assignment field, while the second field is a Frequency domain resource assignment field.

In one embodiment, the first field is a timeDomainAllocation parameter, while the second field is a frequencyDomainAllocation parameter.

In one embodiment, the specific definitions of the Time domain resource assignment field and the Frequency domain resource assignment field can be found in 3GPP TS38.212, Section 7.3.1.1.

In one embodiment, the specific definitions of the timeDomainAllocation parameter and the frequencyDomainAllocation parameter can be found in 3GPP TS38.214, Section 6.1.2.3.

In one embodiment, a first signaling schedules the first signal.

In one embodiment, a first signaling indicates scheduling information of the first signal.

In one embodiment, the first signaling is an RRC signaling.

In one embodiment, the first signaling is a MAC CE.

In one embodiment, the first signaling is a physical layer signaling.

In one embodiment, the first signaling is a Downlink Control Information (DCI) signaling.

In one embodiment, the first signaling is an Uplink Grant DCI signaling.

In one embodiment, the first signaling schedules an uplink physical layer data channel (i.e., an uplink channel capable of bearing physical layer data).

In one embodiment, the uplink physical layer data channel is a Physical Uplink Shared CHannel (PUSCH).

In one embodiment, the uplink physical layer data channel is a short PUSCH (sPUSCH).

In one embodiment, the uplink physical layer data channel is a Narrow Band PUSCH (NPUSCH).

In one embodiment, the scheduling information of the first signal comprises: at least one of time-domain resources occupied, frequency-domain resources occupied, a Modulation and Coding Scheme (MCS), configuration information of DeModulation Reference Signals (DMRS), a Hybrid Automatic Repeat reQuest (HARQ) process ID, a Redundancy Version (RV), a New Data Indicator (NDI), a transmission antenna port, or a corresponding Transmission Configuration Indicator (TCI) state.

In one subembodiment, the configuration information of the DMRS comprises at least one of a Reference Signal (RS) sequence, a mapping mode, a DMRS type, time-domain resources being occupied, frequency-domain resources being occupied, code-domain resources being occupied, a cyclic shift, or an Orthogonal Cover Code (OCC).

In one subembodiment, time-domain resources occupied by the first time-frequency resource block comprise the time-domain resources occupied by the first signal, while frequency-domain resources occupied by the first time-frequency resource block comprise the frequency-domain resources occupied by the first signal.

In one embodiment, the first reference signal resource set comprises M reference signal resources, M being a positive integer greater than 1; the M reference signal resources are respectively identified by M indexes; the first index group consists of at least one index among the M indexes.

In one embodiment, any reference signal resource among the M reference signal resources is an SRS resource.

In one embodiment, the second information block comprises the M indexes.

In one embodiment, the second information block comprises an IE SRS-Config.

In one embodiment, the second information block comprises a parameter srs-ResourceSetToAddModList.

In one embodiment, the second information block comprises a field SRS-ResourceSet in an IE SRS-Config.

In one embodiment, the second information block comprises a field SRS-ResourceSet of which a value of a usage field is nonCodebook.

In one embodiment, the second information block comprises a field SRS-ResourceSet of which a value of a usage field is codebook.

In one embodiment, any index among the M indexes is an SRI.

In one embodiment, any index among the M indexes is an SRS-ResourceId.

In one embodiment, the M indexes are configured by a srs-ResourceIdList.

In one embodiment, the first index group only comprises one index.

In one embodiment, the first index group comprises more than one index.

In one embodiment, any index in the first index group is an SRS-ResourceId.

In one embodiment, the first signaling explicitly indicates a first index group.

In one embodiment, the first signaling implicitly indicates a first index group.

In one embodiment, a number of index(es) comprised by the first index group is determined according to whether the first signal comprises a Codebook based uplink transmission or a Non-Codebook based uplink transmission.

In one embodiment, when the first signal comprises a Codebook based uplink transmission, the number of index(es) comprised by the first index group is equal to 1; when the first signal comprises a Non-Codebook based uplink transmission, the number of index(es) comprised by the first index group is no less than 1.

In one embodiment, the first signaling comprises a third field, and the third field in the first signaling is used to indicate the first index group; the third field in the first signaling comprising at least one bit.

In one subembodiment, the third field in the first signaling explicitly indicates the first index group.

In one subembodiment, the third field in the first signaling implicitly indicates the first index group.

In one subembodiment, a value of the third field in the first signaling indicates the first index group.

In one subembodiment, the value of the third field in the first signaling is one of J candidate values, where J is a positive integer greater than 1, and the J candidate values are non-negative integers that are mutually different; the J candidate values respectively correspond to J index groups; the first index group is an index group corresponding to the value of the third field in the first signaling among the J index groups.

In one subembodiment, the value of the third field in the first signaling is one of J candidate values, where J is a positive integer greater than 1, and the J candidate values are 0, 1..., J-1, respectively; the J candidate values respectively correspond to J index groups; the first index group is an index group corresponding to the value of the third field in the first signaling among the J index groups.

In one subembodiment, a number of reference signal resource(s) comprised by the first reference signal resource set is used to determine a number of bit(s) (i.e., bit size) comprised by the third field in the first signaling.

In one subembodiment, M is used to determine the number of bit(s) comprised by the third field in the first signaling.

In one embodiment, the third field is an SRS resource indicator field.

In one embodiment, the specific definition of the SRS resource indicator field can be found in 3GPP TS38.212, section 7.3.1.1.

In one embodiment, the first index group only comprises the first index.

In one embodiment, the first index group comprises M1 indexes, any index of the M1 indexes being a non-negative integer, where M1 is a positive integer greater than 1.

In one embodiment, the first index is an index among the M1 indexes.

In one embodiment, the first index is any index among the M1 indexes.

In one embodiment, the M1 indexes are mutually different.

In one embodiment, the first index is an SRI.

In one embodiment, the first index is an SRS-ResourceId.

In one embodiment, the first index group is used to indicate a first reference signal resource in the first reference signal resource set.

In one embodiment, the first reference signal resource is identified by a first index, the first index belonging to the first index group.

In one embodiment, the first reference signal resource set comprises M reference signal resources, M being a positive integer greater than 1; the M reference signal resources are respectively identified by M indexes; the first index group comprises a first index, and the first reference signal resource is a reference signal resource in the first reference signal resource set that is identified by the first index, the first reference signal resource being one of the M reference signal resources.

In one embodiment, the phrase that “a given reference signal resource is identified by a given index” includes a meaning that: the given index is used to determine the given reference signal resource.

In one embodiment, the phrase that “a given reference signal resource is identified by a given index” includes a meaning that: the given index is used to indicate the given reference signal resource.

In one embodiment, the phrase that “a given reference signal resource is identified by a given index” includes a meaning that: the given index explicitly indicates the given reference signal resource.

In one embodiment, the phrase that “a given reference signal resource is identified by a given index” includes a meaning that: the given index implicitly indicates the given reference signal resource.

In one embodiment, the phrase that “a given reference signal resource is identified by a given index” includes a meaning that: the given index is an index of the given reference signal resource.

In one embodiment, when the first signal comprises a Codebook based uplink transmission, the first reference signal resource is used to determine a codebook to which a precoder of the first signal belongs.

In one embodiment, a precoder of the first signal belongs to an uplink codebook of the first reference signal resource having identical numbers of antenna ports.

In one embodiment, a precoder of the first signal is determined according to a first parameter set, the first parameter set comprising the first reference signal resource.

In one embodiment, when the first signal comprises a Codebook based uplink transmission, the first parameter set comprises the first reference signal resource, a TPMI and a transmission rank.

In one embodiment, the first signal comprises a Non-Codebook based uplink transmission; when the first index group comprises only the first index, the first parameter set only comprises the first reference signal resource.

In one embodiment, the first reference signal resource is used to determine a spatial-domain relation of the first signal.

### Embodiment 10

Embodiment 10 illustrates a schematic diagram of a first reference signal resource set according to another embodiment of the present application; as shown in FIG. 10.

In Embodiment 10, the operating in the present application is receiving, and the executing in the present application is transmitting; the first node receives a first reference signal resource set, while the second node transmits the first reference signal resource set.

In one embodiment, the operating is receiving, and the executing is transmitting.

In one embodiment, the first reference signal resource set comprises CSI-RS resources.

In one embodiment, the first reference signal resource set comprises NZP CSI-RS resources.

In one embodiment, any reference signal resource in the first reference signal resource set is a CSI-RS resource.

In one embodiment, any reference signal resource in the first reference signal resource set is an NZP CSI-RS resource.

In one embodiment, the first signal comprises an SRS resource.

In one embodiment, the first signal is an SRS resource.

In one embodiment, the first signal is an aperiodic SRS resource.

In one embodiment, the first signal is a periodic SRS resource.

In one embodiment, the first signal is a semi-persistent SRS resource.

In one embodiment, the first signal is used for non-codebook-based uplink transmission.

In one embodiment, the first signal is used to determine a spatial-domain relation of non-codebook-based uplink transmission.

In one embodiment, the first signaling is an RRC signaling.

In one embodiment, the first signaling is a MAC CE.

In one embodiment, the first signaling is a physical layer signaling.

In one embodiment, the first signaling is a Downlink Control Information (DCI) signaling.

In one embodiment, the first signaling is an Uplink Grant DCI signaling.

In one embodiment, the first signaling is a Downlink Grant DCI signaling.

In one embodiment, the first signaling comprises an IE SRS-Config.

In one embodiment, the first signaling comprises a parameter srs-ResourceSetToAddModList.

In one embodiment, the first signaling comprises a parameter srs-ResourceToAddModList.

In one embodiment, the first signaling comprises a parameter SRS-Resource.

In one embodiment, the first signaling comprises a parameter SRS-ResourceSet.

In one embodiment, a value of a parameter usage comprised by the first signaling is an SRS-ResourceSet field of a nonCodebook.

In one embodiment, a first signaling is used for indicating the first signal.

In one embodiment, a first signaling explicitly indicates the first signal.

In one embodiment, a first signaling implicitly indicates the first signal.

In one embodiment, a first signaling indicates an index of the first signal.

In one embodiment, a first signaling is used for triggering the first signal.

In one embodiment, the first signaling explicitly indicates a first time-frequency resource block.

In one embodiment, the first signaling implicitly indicates a first time-frequency resource block.

In one embodiment, the first signaling is used for indicating the first signal, where configuration information of the first signal comprises the first time-frequency resource block.

In one embodiment, a first signaling indicates configuration information of the first signal.

In one embodiment, configuration information of the first signal comprises the first time-frequency resource block.

In one embodiment, a first signaling comprises a fourth field, the fourth field in the first signaling being used to indicate a first time-frequency resource block; the fourth field in the first signaling comprising at least one bit.

In one embodiment, a first signaling comprises a fourth field, the fourth field in the first signaling indicating the first signal.

In one embodiment, the fourth field is an SRS request field.

In one embodiment, for the specific definition of the SRS request field, refer to 3GPP TS38.212, Section 7.3.1.

In one embodiment, configuration information of the first signal comprises at least one of a number of ports, a time-domain behavior, time-domain resources being occupied, frequency-domain resources being occupied, a frequency-hopping bandwidth, a Cyclic shift, a Transmission comb value, a Transmission comb offset, an associated CSI-RS or a spatial-domain relation.

In one embodiment, configuration information of the first signal comprises at least one of time-domain resources being occupied, frequency-domain resources being occupied, an associated CSI-RS or a spatial-domain relation.

In one embodiment, the time-domain resources being occupied in configuration information of the first signal comprises time-domain resources occupied by the first time-frequency resource block, while the frequency-domain resources being occupied in the configuration information of the first signal comprises frequency-domain resources occupied by the first time-frequency resource block.

In one embodiment, the time-domain resources being occupied in configuration information of the first signal comprises a slot-level period and a slot-level offset, a number of symbols, and a starting symbol in a slot.

In one embodiment, the time-domain behavior in configuration information of the first signal is Aperiodic, or semi-persistent, or periodic.

In one embodiment, the first index group indicates the associated CSI-RS in the configuration information of the first signal.

In one embodiment, the first index group indicates the spatial-domain relation in the configuration information of the first signal.

In one embodiment, the first index group is an NZP-CSI-RS-ResourceId.

In one embodiment, any index in the first index group is an NZP-CSI-RS-ResourceId.

In one embodiment, the first index is an NZP-CSI-RS-ResourceId.

In one embodiment, the first signaling comprises a parameter associatedCSI-RS.

In one embodiment, the first signaling comprises a parameter spatialRelationInfo.

In one embodiment, the first index group is configured by a parameter associatedCSI-RS.

In one embodiment, configuration information of the first signal comprises the first index group.

In one embodiment, configuration information of the first signal comprises an index in the first index group.

In one embodiment, configuration information of the first signal comprises the first index.

In one embodiment, the first reference signal resource is used to determine a spatial-domain relation of the first signal.

In one embodiment, a spatial-domain relation of the first signal includes a precoder of the first signal.

In one embodiment, a measurement of the first reference signal resource is used for calculating a precoder of the first signal.

In one embodiment, a precoder of the first signal is calculated based on a channel estimated by a measurement of the first reference signal resource.

### Embodiment 11

Embodiment 11 illustrates a schematic diagram of a first target reference signal resource according to one embodiment of the present application; as shown in FIG. 11.

In Embodiment 11, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain.

In one embodiment, time-domain resources occupied by the second signaling are used to determine a first time; the first time-frequency resource block is later than the first time in time domain; the first target reference signal resource is used to determine a spatial-domain relation of a transmission of any reference signal resource in the first reference signal resource set that is later than the first time in time domain.

In one embodiment, the phrase that “a given time-frequency resource block is no earlier than a given time in time domain” includes a meaning that: a start time of the given time-frequency resource block is no earlier than the given time.

In one embodiment, the phrase that “a given time-frequency resource block is no earlier than a given time in time domain” includes a meaning that: a start time of the given time-frequency resource block is later than the given time.

In one embodiment, the phrase that “a given time-frequency resource block is no earlier than a given time in time domain” includes a meaning that: any symbol comprised by the given time-frequency resource block is no earlier than the given time.

In one embodiment, the phrase that “a given time-frequency resource block is no earlier than a given time in time domain” includes a meaning that: any symbol comprised by the given time-frequency resource block is later than the given time.

In one embodiment, the phrase that “a given time-frequency resource block is later than a given time in time domain” includes a meaning that: a start time of the given time-frequency resource block is later than the given time.

In one embodiment, the phrase that “a given time-frequency resource block is later than a given time in time domain” includes a meaning that: any symbol comprised by the given time-frequency resource block is later than the given time.

In one embodiment, the phrase that “a given time-frequency resource block is no later than a given time in time domain” includes a meaning that: a start time of the given time-frequency resource block is no later than the given time.

In one embodiment, the phrase that “a given time-frequency resource block is no later than a given time in time domain” includes a meaning that: an end time of the given time-frequency resource block is no later than the given time.

In one embodiment, the phrase that “a given time-frequency resource block is no later than a given time in time domain” includes a meaning that: any symbol comprised by the given time-frequency resource block is no later than the given time.

In one embodiment, the phrase that “a given time-frequency resource block is earlier than a given time in time domain” includes a meaning that: a start time of the given time-frequency resource block is earlier than the given time.

In one embodiment, the phrase that “a given time-frequency resource block is earlier than a given time in time domain” includes a meaning that: an end time of the given time-frequency resource block is earlier than the given time.

In one embodiment, the phrase that “a given time-frequency resource block is earlier than a given time in time domain” includes a meaning that: any symbol comprised by the given time-frequency resource block is earlier than the given time.

In one embodiment, the given time-frequency resource block is the first time-frequency resource block.

In one embodiment, the given time-frequency resource block is a transmission of any reference signal resource in the first reference signal resource set.

In one embodiment, the given time-frequency resource block is a transmission of the first reference signal resource.

In one embodiment, the given time is the first time.

In one embodiment, the given time-frequency resource block is the most recent transmission of the first reference signal resource.

In one embodiment, time-domain resources occupied by the first signaling are no earlier than the first time.

In one embodiment, time-domain resources occupied by the first signaling are later than the first time.

In one embodiment, a time interval between the first time and a first reference time is a first interval; the first reference time is no later than the first time, time-domain resources occupied by the second signaling being used to determine the first reference time.

In one embodiment, the first reference time is a start time of time-domain resources occupied by the second signaling.

In one embodiment, the first reference time is an end time of time-domain resources occupied by the second signaling.

In one embodiment, the first reference time is a start time of a time unit to which the second signaling belongs in time domain.

In one embodiment, the first reference time is an end time of a time unit to which the second signaling belongs in time domain.

In one embodiment, a said time unit is a slot.

In one embodiment, a said time unit is a sub-slot.

In one embodiment, a said time unit is a symbol.

In one embodiment, a said time unit comprises a positive integer number of consecutive symbols.

In one embodiment, a number of symbol(s) comprised in a said time unit is configured by a higher-layer parameter.

In one embodiment, the first interval is measured in the time unit.

In one embodiment, the first interval is measured in slots.

In one embodiment, the first interval is measured in sub-slots.

In one embodiment, the first interval is measured in symbols.

In one embodiment, the first interval is a non-negative integer.

In one embodiment, the first interval is equal to 0.

In one embodiment, the first interval is greater than 0.

In one embodiment, the first interval is fixed.

In one embodiment, the first interval is configured by a higher layer parameter.

In one embodiment, the second signaling indicates the first interval.

In one embodiment, the second signaling indicates the first time.

In one embodiment, the first interval is equal to a sum of a second interval and a third interval, where the second interval and the third interval are non-negative integers, respectively.

In one embodiment, the second signaling indicates the second interval and the third interval respectively.

In one embodiment, the second signaling indicates the second interval.

In one embodiment, the third interval is fixed.

In one embodiment, the third interval is configured by a higher layer parameter.

### Embodiment 12

Embodiment 12 illustrates a schematic diagram of a first target reference signal resource according to another embodiment of the present application; as shown in FIG. 12.

In Embodiment 12, a spatial-domain relation of a transmission of any reference signal resource in the first reference signal resource set that is earlier than the first time in time domain is unrelated to the first target reference signal resource.

In one embodiment, the phrase that “a spatial-domain relation of a given transmission is unrelated to the first target reference signal resource” includes a meaning that: the first target reference signal resource is not used to determine the spatial-domain relation of the given transmission.

In one embodiment, the phrase that “a spatial-domain relation of a given transmission is unrelated to the first target reference signal resource” includes a meaning that: a first Transmission Configuration Indicator (TCI) state indicates the first target reference signal resource, while a second TCI state is used to determine a spatial-domain relation of the given transmission, where the first TCI state is different from the second TCI state.

In one embodiment, the phrase that “a spatial-domain relation of a given transmission is unrelated to the first target reference signal resource” includes a meaning that: a spatial-domain relation of the given transmission is different from a spatial domain filter of the first target reference signal resource.

In one embodiment, the phrase that “a spatial-domain relation of a given transmission is unrelated to the first target reference signal resource” includes a meaning that: a spatial-domain relation of the given transmission is different from a spatial-domain relation of the first target reference signal resource.

In one embodiment, the phrase that “a spatial-domain relation of a given transmission is unrelated to the first target reference signal resource” includes a meaning that: a second target reference signal resource is used to determine a spatial-domain relation of the given transmission, where the second target reference signal resource is different from the first target reference signal resource.

In one embodiment, the phrase that “a spatial-domain relation of a given transmission is unrelated to the first target reference signal resource” includes a meaning that: a second target reference signal resource is used to determine a spatial-domain relation of the given transmission, where the second target reference signal resource is non-QCL with the first target reference signal resource.

In one embodiment, the phrase that “a spatial-domain relation of a given transmission is unrelated to the first target reference signal resource” includes a meaning that: a second target reference signal resource is used to determine a spatial-domain relation of the given transmission, where a spatial domain filter for the second target reference signal resource is different from that for the first target reference signal resource.

In one embodiment, the given transmission is a transmission of any reference signal resource in the first reference signal resource set that is earlier than the first time in time domain.

In one embodiment, the given transmission is a transmission of any reference signal resource in the first reference signal resource set.

In one embodiment, the given transmission is a most recent transmission of one of the M1 reference signal resources other than the first reference signal resource.

In one embodiment, the given transmission is a most recent transmission of any reference signal resource among the M1 reference signal resources.

In one embodiment, the given transmission is a transmission of any reference signal resource among the M1 reference signal resources.

In one embodiment, the second target reference signal resource comprises a Channel State Information-Reference Signal (CSI-RS) resource.

In one embodiment, the second target reference signal resource comprises a Non-Zero Power (NZP) CSI-RS resource.

In one embodiment, the second target reference signal resource comprises a Synchronisation Signal/physical broadcast channel Block (SSB) resource.

In one embodiment, the second target reference signal resource comprises a Sounding Reference Signal (SRS) resource.

In one embodiment, the second target reference signal resource is a CSI-RS resource or an SSB resource.

In one embodiment, the second target reference signal resource is one of a CSI-RS resource, an SSB resource or an SRS resource.

In one embodiment, an index of the second target reference signal resource includes an NZP-CSI-RS-ResourceId.

In one embodiment, an index of the second target reference signal resource includes an NZP-CSI-RS-ResourceSetId.

In one embodiment, an index of the second target reference signal resource includes an SSB-Index.

In one embodiment, an index of the second target reference signal resource includes an SRS-ResourceSetId.

In one embodiment, an index of the second target reference signal resource includes an SRS-ResourceId.

In one embodiment, a third signaling is used for indicating the second target reference signal resource, time-domain resources occupied by the third signaling being earlier than time-domain resources occupied by the second signaling.

In one embodiment, a third signaling is a physical layer signaling.

In one embodiment, the third signaling is a piece of Downlink Control Information (DCI).

In one embodiment, the third signaling comprises DownLink Grant DCI.

In one embodiment, the third signaling comprises UpLink Grant DCI.

In one embodiment, the third signaling explicitly indicates a second target reference signal resource.

In one embodiment, the third signaling implicitly indicates a second target reference signal resource.

In one embodiment, the third signaling indicates the second target reference signal resource.

In one embodiment, the third signaling indicates an index of the second target reference signal resource.

In one embodiment, the third signaling indicates a second Transmission Configuration Indicator (TCI) state, the second TCI state indicating the second target reference signal resource.

In one embodiment, the third signaling indicates a second TCI state in N TCI states, the second TCI state indicating the second target reference signal resource, where N is a positive integer greater than 1.

In one embodiment, the third signaling indicates a TCI codepoint corresponding to the second TCI state.

In one embodiment, the third signaling comprises a first field, the first field comprising at least one bit; the first field in the third signaling indicates the second target reference signal resource.

In one embodiment, the first field in the third signaling indicates the second TCI state.

In one embodiment, a value of the first field in the third signaling is equal to a TCI codepoint corresponding to the second TCI state.

### Embodiment 13

Embodiment 13 illustrates a schematic diagram of determining whether a first condition is satisfied according to one embodiment of the present application; as shown in FIG. 13.

In Embodiment 13, time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

In one embodiment, whether the most recent transmission of the first reference signal resource is earlier or later than the first time is used to determine whether the first sub-condition is satisfied.

In one embodiment, the first reference signal resource set comprises at least one reference signal resource among the M reference signal resources.

In one embodiment, any reference signal resource in the first reference signal resource set is one of the M reference signal resources.

In one embodiment, when the most recent transmission of the first reference signal resource is no earlier than the first time in time domain, the first condition is satisfied.

In one embodiment, when the most recent transmission of the first reference signal resource is no earlier than the first time in time domain, the first sub-condition is satisfied.

In one embodiment, when the most recent transmission of the first reference signal resource is later than the first time in time domain, the first sub-condition is satisfied.

In one embodiment, when the most recent transmission of the first reference signal resource is no earlier than the first time in time domain, the first condition is satisfied.

In one embodiment, when the most recent transmission of the first reference signal resource is earlier than the first time in time domain, the first condition is unsatisfied.

In one embodiment, when the most recent transmission of the first reference signal resource is earlier than the first time in time domain, the first sub-condition is unsatisfied.

### Embodiment 14

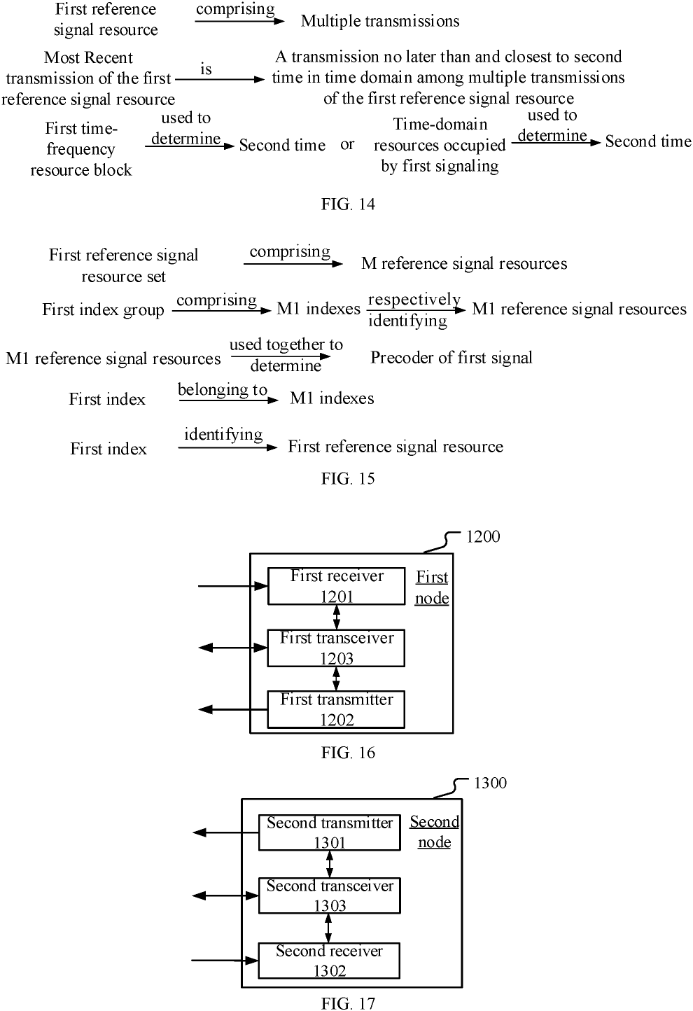

Embodiment 14 illustrates a schematic diagram of a most recent transmission of a first reference signal resource according to one embodiment of the present application; as shown in FIG. 14.

In Embodiment 14, the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

In one embodiment, the most recent transmission of the first reference signal resource is a transmission earlier than and closest to a second time in time domain among the multiple transmissions of the first reference signal resource.

In one embodiment, the most recent transmission of the first reference signal resource is a transmission of which a corresponding start time is no later than and closest to a second time among the multiple transmissions of the first reference signal resource.

In one embodiment, the most recent transmission of the first reference signal resource is a transmission of which a corresponding start time is no later than and closest to a second time among the multiple transmissions of the first reference signal resource.

In one embodiment, the first time-frequency resource block is used to determine the second time.

In one embodiment, time-domain resources occupied by the first signaling are used to determine the second time.

In one embodiment, the second time is a start time of the first time-frequency resource block in time domain.

In one embodiment, the second time is an end time of the first time-frequency resource block in time domain.

In one embodiment, the second time is an end time of a time unit to which the first time-frequency resource block belongs in time domain.

In one embodiment, the second time is a start time of a time unit to which the first time-frequency resource block belongs in time domain.

In one embodiment, a time unit to which the first signaling belongs in time domain is used to determine the second time.

In one embodiment, the second time is a start time of the first signaling in time domain.

In one embodiment, the second time is an end time of the first signaling in time domain.

In one embodiment, the second time is an end time of a time unit to which the first signaling belongs in time domain.

In one embodiment, the second time is a start time of a time unit to which the first signaling belongs in time domain.

In one embodiment, the multiple transmissions are mutually orthogonal in time domain.

### Embodiment 15

Embodiment 15 illustrates a schematic diagram of a first index group being used to determine M1 reference signal resources from the first reference signal resource set according to one embodiment of the present application; as shown in FIG. 15.

In Embodiment 15, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources.

In one embodiment, the first reference signal resource is any reference signal resource among the M1 reference signal resources.

In one embodiment, the first index group is used to determine M1 reference signal resources from the first reference signal resource set, the first reference signal resource being one of the M1 reference signal resources, where M1 is a positive integer; the M1 reference signal resources are used together to determine a precoder of the first signal.

In one embodiment, a precoder of the first signal is determined according to a first parameter set, the first parameter set comprising the M1 reference signal resources.

In one embodiment, the first signal comprises a Non-Codebook based uplink transmission; when the first index group comprises the M1 indexes, the first parameter set only comprises the M1 reference signal resources.

### Embodiment 16

Embodiment 16 illustrates a structure block diagram of a processing device used in a first node according to one embodiment of the present application; as shown in FIG. 16. In FIG. 16, a processing device 1200 in a first node comprises a first receiver 1201, a first transmitter 1202 and a first transceiver 1203.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460 or the data source 467 in Embodiment 4.

In one embodiment, the first transceiver 1203 comprises at least one of the antenna 452, the receiver/transmitter 454, the receiving processor 456, the multi-antenna receiving processor 458, the transmitting processor 468, the multi-antenna transmitting processor 457, the controller/processor 459, the memory 460 or the data source 467 in Embodiment 4.

In one embodiment, the operating is receiving, the first transceiver 1203 comprising at least one of the antenna 452, the receiver 454, the receiving processor 456, the multi-antenna receiving processor 458, the controller/processor 459, the memory 460 or the data source 467 in Embodiment 4.

In one embodiment, the operating is transmitting, the first transceiver 1203 comprising at least one of the antenna 452, the transmitter 454, the transmitting processor 468, the multi-antenna transmitting processor 457, the controller/processor 459, the memory 460 or the data source 467 in Embodiment 4.

The first receiver 1201 receives a second signaling; receives a first signaling, the first signaling being used for indicating a first time-frequency resource block; and
the first transceiver 1203 operates a first reference signal resource set; and
the first transmitter 1202 transmits a first signal in the first time-frequency resource block when a first condition is satisfied; or, drops transmitting the first signal in the first time-frequency resource block when the first condition is unsatisfied.

In Embodiment 16, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

In one embodiment, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain.

In one embodiment, a spatial-domain relation of a transmission of any reference signal resource in the first reference signal resource set that is earlier than the first time in time domain is unrelated to the first target reference signal resource.

In one embodiment, time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

In one embodiment, the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

In one embodiment, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources.

In one embodiment, the first condition also comprises: the first target reference signal resource being used to determine a spatial-domain relation of a most recent transmission of each reference signal resource other than the first reference signal resource among the M1 reference signal resources.

### Embodiment 17

Embodiment 17 illustrates a structure block diagram of a processing device used in a second node according to one embodiment of the present application; as shown in FIG. 17. In FIG. 17, a processing device 1300 in a second node comprises a second transmitter 1301, a second receiver 1302 and a second transceiver 1303.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475 or the memory 476 in Embodiment 4.

In one embodiment, the second receiver 1302 comprises at least one of the antenna 420, the receiver 418, the receiving processor 470, the multi-antenna receiving processor 472, the controller/processor 475 or the memory 476 in Embodiment 4.

In one embodiment, the second transceiver 1303 comprises at least one of the antenna 420, the transmitter/receiver 418, the transmitting processor 416, the multi-antenna transmitting processor 471, the receiving processor 470, the multi-antenna receiving processor 472, the controller/processor 475 or the memory 476 in Embodiment 4.

In one embodiment, the executing is transmitting, the second transceiver 1303 comprising at least one of the antenna 420, the transmitter 418, the transmitting processor 416, the multi-antenna transmitting processor 471, the controller/processor 475 or the memory 476 in Embodiment 4.

In one embodiment, the executing is receiving, the second transceiver 1303 comprising at least one of the antenna 420, the receiver 418, the receiving processor 470, the multi-antenna receiving processor 472, the controller/processor 475 or the memory 476 in Embodiment 4.

The second transmitter 1301 transmits a second signaling; and transmits a first signaling, the first signaling being used for indicating a first time-frequency resource block; and
the second transceiver 1303 executes a first reference signal resource set; and
the second receiver 1302 monitors a first signal in the first time-frequency resource block.

In Embodiment 17, the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

In one embodiment, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain.

In one embodiment, a spatial-domain relation of a transmission of any reference signal resource in the first reference signal resource set that is earlier than the first time in time domain is unrelated to the first target reference signal resource.

In one embodiment, time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

In one embodiment, the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

In one embodiment, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources.

In one embodiment, the first condition also comprises: the first target reference signal resource being used to determine a spatial-domain relation of a most recent transmission of each reference signal resource other than the first reference signal resource among the M1 reference signal resources.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a second signaling; and receiving a first signaling, the first signaling being used for indicating a first time-frequency resource block; and
a first transceiver, operating a first reference signal resource set; and
a first transmitter, transmitting a first signal in the first time-frequency resource block when a first condition is satisfied; or, dropping transmitting the first signal in the first time-frequency resource block when the first condition is unsatisfied;
wherein the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

2. The first node according to claim 1, characterized in that
time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain;
or, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain; a spatial-domain relation of a transmission of any reference signal resource in the first reference signal resource set that is earlier than the first time in time domain is unrelated to the first target reference signal resource.

3. The first node according to claim 1, characterized in that time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

4. The first node according to claim 1, characterized in that the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

5. The first node according to claim 1, characterized in that
the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources;
or, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources; the first condition also comprises: the first target reference signal resource being used to determine a spatial-domain relation of a most recent transmission of each reference signal resource other than the first reference signal resource among the M1 reference signal resources.

6. A second node for wireless communications, characterized in comprising:
a second transmitter, transmitting a second signaling; and transmitting a first signaling, the first signaling being used for indicating a first time-frequency resource block; and
a second transceiver, executing a first reference signal resource set; and
a second receiver, monitoring a first signal in the first time-frequency resource block;
wherein the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

7. The second node according to claim 6, characterized in that
time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain;
or, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain; a spatial-domain relation of a transmission of any reference signal resource in the first reference signal resource set that is earlier than the first time in time domain is unrelated to the first target reference signal resource.

8. The second node according to claim 6, characterized in that time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

9. The second node according to claim 6, characterized in that the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

10. The second node according to claim 6, characterized in that
the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources;
or, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources; the first condition also comprises: the first target reference signal resource being used to determine a spatial-domain relation of a most recent transmission of each reference signal resource other than the first reference signal resource among the M1 reference signal resources.

11. A method in a first node for wireless communications, characterized in comprising:
receiving a second signaling and operating a first reference signal resource set;
receiving a first signaling, the first signaling being used for indicating a first time-frequency resource block; and
transmitting a first signal in the first time-frequency resource block when a first condition is satisfied; or, dropping transmitting the first signal in the first time-frequency resource block when the first condition is unsatisfied;
wherein the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; the first condition comprises: the first target reference signal resource being used to determine a spatial-domain relation of a most recent transmission of the first reference signal resource; the operating is transmitting, or, the operating is receiving.

12. The method according to claim 11, characterized in that
time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain;
or, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain; a spatial-domain relation of a transmission of any reference signal resource in the first reference signal resource set that is earlier than the first time in time domain is unrelated to the first target reference signal resource.

13. The method according to claim 11, characterized in that time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

14. The method according to claim 11, characterized in that the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

15. The method according to claim 11, characterized in that
the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources;
or, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources; the first condition also comprises: the first target reference signal resource being used to determine a spatial-domain relation of a most recent transmission of each reference signal resource other than the first reference signal resource among the M1 reference signal resources.

16. A method in a second node for wireless communications, characterized in comprising:
transmitting a second signaling and executing a first reference signal resource set;
transmitting a first signaling, the first signaling being used for indicating a first time-frequency resource block; and
monitoring a first signal in the first time-frequency resource block;
wherein the first signaling is used for indicating a first index group, the first index group comprising at least one index, of which each index is a non-negative integer; the first index group is used to determine a first reference signal resource from the first reference signal resource set, the first reference signal resource belonging to the first reference signal resource set, and the first reference signal resource being identified by an index in the first index group; the first reference signal resource is used to determine a precoder of the first signal; the second signaling is used for indicating a first target reference signal resource; when a first condition is satisfied, a target receiver of the first signaling transmits a first signal in the first time-frequency resource block; when the first condition is unsatisfied, the target receiver of the first signaling drops transmitting the first signal in the first time-frequency resource block; the first condition comprises: the first target reference signal resource being used to determine a spatial-domain relation of a most recent transmission of the first reference signal resource; the executing is receiving, or, the executing is transmitting.

17. The method according to claim 16, characterized in that
time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain;
or, time-domain resources occupied by the second signaling are used to determine a first time; the first time-frequency resource block is no earlier than the first time in time domain; the first target reference signal resource is used to determine a spatial-domain relation of a transmission of any reference signal resource in the first reference signal resource set that is no earlier than the first time in time domain; a spatial-domain relation of a transmission of any reference signal resource in the first reference signal resource set that is earlier than the first time in time domain is unrelated to the first target reference signal resource.

18. The method according to claim 16, characterized in that time-domain resources occupied by the second signaling are used to determine a first time; the first time-frequency resource block is no earlier than the first time in time domain; whether the most recent transmission of the first reference signal resource is earlier or later than the first time is used to determine whether the first condition is satisfied.

19. The method according to claim 16, characterized in that the first reference signal resource comprises multiple transmissions, and the most recent transmission of the first reference signal resource is a transmission no later than and closest to a second time in time domain among the multiple transmissions of the first reference signal resource; the first time-frequency resource block is used to determine the second time, or, time-domain resources occupied by the first signaling are used to determine the second time.

20. The method according to claim 16, characterized in that the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources;
or, the first reference signal resource set comprises M reference signal resources, M being a positive integer greater than 1; the M reference signal resources are respectively identified by M indexes; the first index group comprises M1 indexes, M1 being a positive integer greater than 1; M1 reference signal resources are reference signal resources in the first reference signal resource set respectively identified by the M1 indexes, and the M1 reference signal resources are used together for determining the precoder of the first signal; the first reference signal resource is identified by a first index, the first index being one of the M1 indexes, and the first reference signal resource being one of the M1 reference signal resources; the first condition also comprises: the first target reference signal resource being used to determine a spatial-domain relation of a most recent transmission of each reference signal resource other than the first reference signal resource among the M1 reference signal resources.
